(19) United States
(12) Patent Application Publication
(10) Pub. No.: US 2024/0202884 A1
(43) Pub. Date: Jun. 20, 2024

(54) IMAGE PROCESSING DEVICE AND BLURRED IMAGE GENERATION METHOD

(71) Applicant: SK hynix Inc., Icheon-si Gyeonggi-do (KR)

(72) Inventor: Kunihiro Yamamoto, Icheon-si Gyeonggi-do (KR)

(73) Assignee: SK hynix Inc., Icheon-si Gyeonggi-do (KR)

(21) Appl. No.: 18/448,666

(22) Filed: Aug. 11, 2023

(30) Foreign Application Priority Data
Dec. 20, 2022 (KR) 10-2022-0179694

(51) Int. Cl. G06T 5/00; G06T 3/40; G06T 7/194

(52) U.S. Cl. CPC G06T 5/002; G06T 3/4007; G06T 7/194; G06T 2207/20016

(57) ABSTRACT

An embodiment relates to an image processing device. The image processing device according to an embodiment includes a pre-processor configured to extract a background area of an image based on pixel data received from an external device and generate a low-resolution sub-image in which the background area is downscaled, a background blur component configured to generate an intermediate image in which a blur operation is performed on the low-resolution sub-image and upscale the intermediate image to original resolution, and an image compositer configured to generate a blurred image in which a foreground area of the image is composited to the upscaled intermediate image.

### CROSS-REFERENCE TO RELATED APPLICATION

The present application claims priority under 35 U.S.C. § 119(a) to Korean patent application number 10-2022-0179694 filed on Dec. 20, 2022, in the Korean Intellectual Property Office, the entire disclosure of which is incorporated by reference herein.

### BACKGROUND

### 1. Technical Field

The present disclosure relates to an image processing device, and more particularly, to an image processing device and a blurred image generation method.

### 2. Related Art

A reflex camera may generate an image in which a blur effect occurs by adjusting the depth of field of an optical system. The size of a CIS image sensor is small, and thus it is difficult for the CIS image sensor to generate an image in which a blur effect occurs.

An image processing device may generate a blur effect on an image by performing an image processing operation. As resolution of the image on which the image processing operation is performed increases, an operation amount for performing image processing may increase. As the operation amount increases, the cost for generation of a high-resolution image on which a blur operation is performed may increase.

An operation amount of blur operation performance may be decreased by lowering resolution of a sensed image. When the operation amount of the blur operation performance may be decreased without image quality deterioration, a high-resolution image in which a blur effect is generated may be obtained.

### SUMMARY

According to an embodiment of the present disclosure, an image processing device may include a pre-processor configured to extract a background area of an image based on pixel data received from an external device and generate a low-resolution sub-image in which the background area is downscaled, a background blur component configured to generate an intermediate image in which a blur operation is performed on the low-resolution sub-image and upscale the intermediate image to original resolution, and an image compositer configured to generate a blurred image in which a foreground area of the image is composited to the upscaled intermediate image.

According to an embodiment of the present disclosure, an image processing method may include extracting a background area of an image based on pixel data received from an external device, generating a low-resolution sub-image in which a downscaling operation is performed on the background area, performing a blur operation on the low-resolution sub-image, upscaling an intermediate image on which the blur operation is performed to original resolution, and compositing the upscaled intermediate image and a foreground area of the image.

According to an embodiment of the present disclosure, an image processing device may include a pre-processor configured to extract a background area of an image based on pixel data received from an external device and generate a low-resolution sub-image for the background area based on an intensity of a blur operation, a background blur component configured to generate an intermediate image in which the blur operation is performed on the low-resolution sub-image and increase resolution of the intermediate image, and an image compositer configured to composite the intermediate image of which resolution is increased to a foreground area of the image.

### BRIEF DESCRIPTION OF THE DRAWINGS

FIG. 1 is a diagram illustrating an image processing device according to an embodiment of the present disclosure.

FIG. 2 is a flowchart illustrating a method of generating a blurred image according to an embodiment of the present disclosure.

FIG. 3 is a flowchart illustrating a method of performing a blur operation according to an embodiment of the present disclosure.

FIG. 4 is a block diagram illustrating an electronic device including an image processing device according to an embodiment of the present disclosure.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and the descriptions are not limited to the embodiments described in the present specification or application.

Hereinafter, in order to describe in detail enough that a person of ordinary skill in the art to which the present disclosure pertains may implement the technical spirit of the present disclosure, an embodiment of the present disclosure is described with reference to the accompanying drawings.

An embodiment of the present disclosure provides an image processing device and an image processing method that perform a blur operation by lowering resolution of a background area of an extracted image and restore the resolution to original resolution after the blur operation to perform a blur operation with a decreased operation amount.

According to an embodiment of the present technology, the image processing device and the image processing method for minimizing an operation amount by performing the blur operation by lowering resolution for the background area of the image, and for generating a high-quality image by restoring the resolution of the blurred background area to the original resolution may be provided.

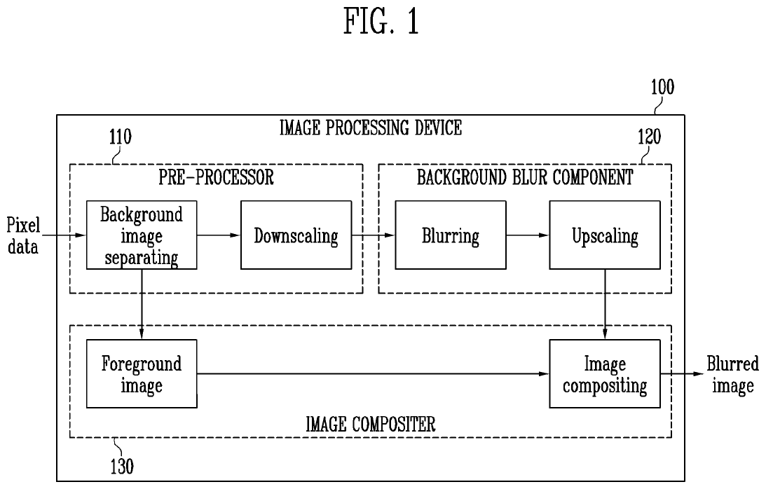

FIG. 1 is a diagram illustrating an image processing device according to an embodiment of the present disclosure.

Referring to FIG. 1, the image processing device 100, may comprise a programmable processor or, functionally-equivalent combinational and sequential logic devices. The image processing device 100 may also comprise program instructions, i.e., software, which cause a processor component of the image processing device 100 to perform or effectuate operations.

The image processing device 100 may generate a blurred image in which a background area is blurred based on received pixel data. The pixel data received by the image processing device 100 may include brightness information and depth information. An image sensor including a phase detection auto focus (PDAF) pixel may generate the pixel data including the brightness information and the depth information and transfer the pixel data to the image processing device 100. The depth information may be information indicating spatial distance which represents perspective information of one point in a two-dimensional image with respect to another point. The depth information may be included in the pixel data through an indirect time-of-flight (iToF) sensor or a direct -time-of-flight (dToF) sensor included in the image sensor.

The image processing device 100 may include a pre-processor 110, a background blur component 120, and an image compositer 130. In an embodiment of the present disclosure, the image processing device 100 may adjust resolution of a background area in order to minimize an operation amount of a blur operation. The blur operation may be an operation blurring an image based on a mean of pixel values included in the pixel data. The image processing device may perform an image processing operation by separating an image into a background area and a foreground area. The foreground area may be an area which is in focus in the image, and the background area may be an area which is out of focus in the image.

The pre-processor 110 may receive the pixel data obtained by capturing the image. The pre-processor 110 may extract the background area of the image based on the pixel data received from an outside. The image may be separated into the background area and the foreground area according to the depth information. In an embodiment of the present disclosure, the blur operation may be performed only on the background area. The foreground area may be composited to the background area on which the blur operation is performed.

The pre-processor 110 may lower the resolution of a background image including the background area. A resolution of an image may be changed whether the image is scaled. The resolution of the image may be lower when the image is downscaled and the resolution of the image may be higher when the image is upscaled. The resolution of the background image may vary according to an intensity of the blur operation to be performed. The pre-processor 110 may generate a low-resolution sub-image in which the background area of the image is downscaled. The low-resolution sub-image may be a temporary image for the blur operation.

The pre-processor 110 may determine target resolution of the low-resolution sub-image based on the intensity of the blur operation. The target resolution may be a resolution at which the blur operation is performed. The pre-processor 110 may perform a downscaling operation on the background image according to the target resolution. In an embodiment of the present disclosure, the pre-processor 110 may determine the target resolution to be less as the intensity of the blur operation increases.

The pre-processor 110 may determine the background area and the foreground area of the image based on the depth information of the image. The pre-processor 110 may determine a size of the background area based on the intensity of the blur operation. For example, the pre-processor 110 may determine the size of the background area to be less as the intensity of the blur operation increases. As the background area increases, the area where the blur operation is performed on the blurred image may increase.

The pre-processor 110 may perform the downscaling operation in a bilinear interpolation method. The bilinear interpolation method is only an example, and the downscaling operation may be performed in various methods of changing resolution of the image. The resolution of the background image may be lowered in response to the downscaling operation. Because a technique of performing downscaling in the bilinear interpolation method corresponds to a known technique, a detailed description of downscaling may be omitted in the specification of the present disclosure. The pre-processor 110 may generate the low-resolution sub-image having the target resolution.

The background blur component 120 may generate an intermediate image in which the blur operation is performed on the low-resolution sub-image. The intermediate image may be an image which is temporarily generated and terminated during the image processing operation. After performing the blur operation, the background blur component 120 may upscale the intermediate image to original resolution. The original resolution may be a resolution of an image which is before downscaling.

The background blur component 120 may determine the intensity of the blur operation based on a depth of field of the blurred image. For example, the background blur component 120 may determine the intensity of the blur operation to be greater as the depth of field is shallower. As a portion corresponding to an in-focus point is narrower in the image, the depth of field may be shallower. In an embodiment of the present disclosure, information on the depth of field may be obtained from a user.

The background blur component 120 may perform the blur operation on the low-resolution sub-image according to the determined intensity of the blur operation.

The background blur component 120 may generate a kernel of a point spread function corresponding to the intensity of the blur operation. In an embodiment of the present disclosure, the point spread function may be a function indicating a spread degree of one point. The kernel of the point spread function may indicate an inclined direction and degree of the point spread function.

The background blur component 120 may perform a convolution operation of the low-resolution sub-image and the kernel. A blur effect may be reproduced in the image through the convolution operation. The background blur component 120 may blur the background area by performing the convolution operation. In an embodiment of the present disclosure, the background blur component 120 may digitally reproduce a blur effect according to a focus of a lens using the kernel of the point spread function.

The background blur component 120 may determine a size of the kernel of the point spread function based on the target resolution. The size of the kernel may vary according to the resolution of the image on which the convolution operation is performed. For example, as the resolution of the image increases, the size of the kernel may increase.

In an embodiment of the present disclosure, a method of using the point spread function to reproduce the blur effect in the image is described, but this is only an example, and the method of reproducing the blur effect in the image may be various. In addition, because the convolution operation of the kernel of the point spread function and the image is a known technique, a detailed description of the convolution operation may be omitted in the specification of the present disclosure.

The background blur component 120 may perform an upscaling operation on the intermediate image in response to the downscaling operation. The background blur component 120 may increase resolution of the intermediate image by the resolution decreased by the downscaling operation.

The background blur component 120 may perform the upscaling operation in a bicubic interpolation method. Similarly to the downscaling operation, the upscaling operation of the bicubic interpolation method is only an example, and the upscaling operation may be performed in various methods of changing the resolution of the image. Because a technique of improving the resolution of the image by performing upscaling using the bicubic interpolation method corresponds to a known technique, a detailed description of upscaling may be omitted in the specification of the present disclosure. The background blur component 120 may upscale the resolution of the intermediate image to the original resolution before downscaling.

The image compositer 130, like the image processing device 100, may be embodied as a processor or combinational and sequential logic devices, which may obtain a foreground image from the image from which the background area is extracted. The image compositer 130 may generate the blurred image in which the foreground area of the image is composited to the upscaled intermediate image. Because resolution of the foreground area is not changed or the blur operation is not performed on the foreground area, image quality deterioration might not occur.

In an embodiment of the present disclosure, resolution of the foreground image and the upscaled intermediate image may be the same. Resolution of the blurred image may be the same as that of the captured image. After the blur operation is performed by lowering resolution of the background area, the resolution is increased to the original resolution, and thus the background area may have the same resolution as the foreground area. The image compositer 130 may composite the foreground area and the background area having the same resolution.

In an embodiment of the present disclosure, a total operation amount of the blur operation may vary according to the intensity of the blur operation or the depth of field of the blurred image. For example, in an embodiment, as the intensity of the blur operation is weaker, the total operation amount may be decreased.

In an embodiment of the present disclosure, a processing speed of the blur operation may increase according to the decrease in the total operation amount, and a load according to performing the blur operation may be decreased. In addition, in an embodiment, because the resolution of the foreground image of the captured image is not changed, the image quality of the foreground image is not deteriorated, and thus a high quality blurred image may be generated.

Because the blur operation essentially an operation of deteriorating the image, there is almost no difference in image quality even though comparing the image of which the resolution is restored after performing the blur operation by lowering the resolution of the background area with the image in which the background area of the original resolution is blurred. The total operation amount of the present disclosure for performing the blur operation after lowering the resolution of the image and restoring the resolution to the original resolution may be less than the operation amount of blurring the background area of the original resolution.

In an embodiment of the present disclosure, it may be assumed that the pre-processor 110 decreases the resolution of the background image by about ¼ times. For example, in an embodiment, when the resolution of the captured image is 4k, resolution of the low-resolution sub-image may be 1024*768. In another embodiment of the present disclosure, the pre-processor 110 may decrease the resolution of the background image by half by generating the low-resolution sub-image having resolution of 1024*768 based on an image having resolution of 2k.

The kernel size of the point spread function may also become about ¼ times correspondingly to a fact that the resolution of the low-resolution sub-image becomes about ¼ times. In an embodiment, when the kernel size of the point spread function corresponding to the original resolution is 31 pixels×31 pixels, the kernel size of the point spread function corresponding to the low-resolution sub-image may be 9 pixels×9 pixels. At this time, an amount of the convolution operation according to the decrease in the kernel size may become about 1/16 times. In addition, the number of pixels of the low-resolution sub-image may become about 1/16 times corresponding to a fact that the resolution of the low-resolution sub-image becomes about ¼ times.

The total operation amount according to the blur operation may be determined according to the number of pixels of the image on which the convolution operation is performed and the size of the kernel. In an embodiment, because the number of pixels of the low-resolution sub-image is about 1/16 times that of the captured image, and the decrease of the operation amount according to the decrease of the kernel size is also about 1/16 times, the total operation amount may be decrease by about 1/256 times an amount of an operation performed without changing resolution. Because the operation amount of the blur operation is decreased, even though the operation of changing the resolution of the intermediate image on which the blur operation is performed to the original resolution is performed, the total operation amount of the blur operation may be less than the operation amount of performing the blur operation on the image of the original resolution.

In another embodiment of the present disclosure, the pre-processor 110 may determine the extracted background area based on the depth of field of the blurred image. For example, as the depth of field increases, the pre-processor 110 may determine the foreground area of the image to be wider and the background area of the image to be narrower.

The pre-processor 110 may determine the target resolution of the background image based on the depth of field of the blurred image. As the depth of field is shallower, the target resolution of the low-resolution sub-image may be lowered. In an embodiment of the present disclosure, the size of the kernel of the point spread function may be decreased as the target resolution is lowered. The operation amount of the blur operation may be less than that of the blur operation on the original resolution image corresponding to the kernel size decrease.

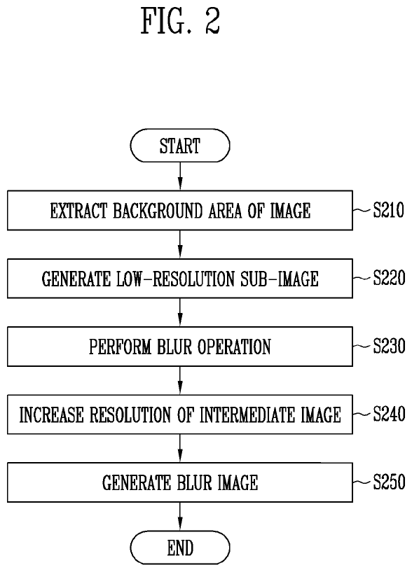

FIG. 2 is a flowchart illustrating a method of generating a blurred image according to an embodiment of the present disclosure.

Referring to FIG. 2, the image processing device may perform the blur operation on the background area of the captured image. The image processing device may generate the blurred image in which the background area is blurred through operation processing. In an embodiment of the present disclosure, the image processing device may decrease the operation amount of the blur operation by decreasing the resolution of the background area on which the blur operation is to be performed.

In step S210, the pre-processor may extract the background area of the image from the pixel data. The pre-processor may distinguish the background area and the foreground area of the image based on the depth information of the image. As the depth of field of the blurred image is shallower, the background area may be wider.

In step S220, the pre-processor may generate the low-resolution sub-image for the background area. The pre-processor may determine the target resolution of the low-resolution sub-image based on the intensity of the blur operation to be performed on the background area. The pre-processor may perform the downscaling operation on the background image including the background area to generate the low-resolution sub-image having the target resolution.

In another embodiment of the present disclosure, the pre-processor may determine the target resolution of the low-resolution sub-image based on the depth of field of the blurred image. The pre-processor may perform the downscaling operation on the background area in the bilinear interpolation method according to the target resolution.

In step S230, the background blur component may perform the blur operation on the low-resolution sub-image. The intensity of the blur operation may be determined according to the depth of field of the blurred image. For example, as the depth of field is shallower, the intensity of the blur operation may be increased. As the intensity of the blur operation is increased, the resolution of the background area may be decreased. The intermediate image having the target resolution may be generated in response to performance of the blur operation.

In step S240, the background blur component may increase the resolution of the intermediate image. The background blur component may change the resolution of the intermediate image to the original resolution by performing the upscaling operation on the intermediate image. In an embodiment of the present disclosure, the resolution of the image may be changed in various methods such as bilinear interpolation and bicubic interpolation.

In another embodiment of the present disclosure, the background blur component may change the resolution of the intermediate image to be different from the original resolution by performing the upscaling operation. The background blur component may upscale the intermediate image by the bicubic interpolation method.

In step S250, the image compositer may generate the blurred image by compositing the foreground area of the image and the upscaled intermediate image. The blurred image may be an image in which the blur operation is performed only on the background area. The resolution of the foreground area and the background area of the blurred image may be the same.

Each step of FIG. 2 may correspond to the description of FIG. 1.

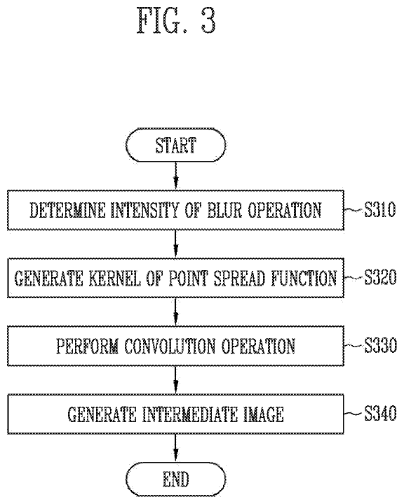

FIG. 3 is a flowchart illustrating a method of performing a blur operation according to an embodiment of the present disclosure.

Referring to FIG. 3, the background blur component may perform the blur operation on the low-resolution sub-image. The background blur component may change the resolution of the intermediate image to the original resolution after performing the blur operation by changing the resolution without directly performing the blur operation on the background area. In an embodiment of the present disclosure, the total operation amount related to the blur operation may be decreased by changing the resolution of the background area.

In step S310, the background blur component may determine the intensity of the blur operation to be performed on the background area. The background blur component may determine the intensity of the blur operation based on the depth of field of the blurred image. In another embodiment of the present disclosure, the intensity of the blur operation may be determined according to the target resolution of the low-resolution sub-image.

In step S320, the background blur component may generate the kernel of the point spread function corresponding to the determined intensity of the blur operation. The kernel size of the point spread function may be determined according to the image on which the convolution operation is performed. The amount of convolution operation may vary according to the kernel size of the point spread function. As the kernel size is decreased, the amount of convolution operation may be decreased, and an operation load of the image processing device may be decreased.

In step S330, the background blur component may perform the convolution operation of the low-resolution sub-image and the point spread function kernel. The blur effect of the optical system may be digitally reproduced in the image on which the convolution operation of the point spread function is performed. The background blur component may implement the blur effect on the low-resolution sub-image.

In step S340, the background blur component may generate the intermediate image in which the blur operation is performed on the low-resolution sub-image. At this time, the resolution of the intermediate image may be the same as that of the low-resolution sub-image. Because, in an embodiment, the resolution of the target image of the convolution operation is lower than the original resolution, the total operation amount of the convolution operation may be decreased.

Each step of FIG. 3 may correspond to a portion of the description of FIG. 1.

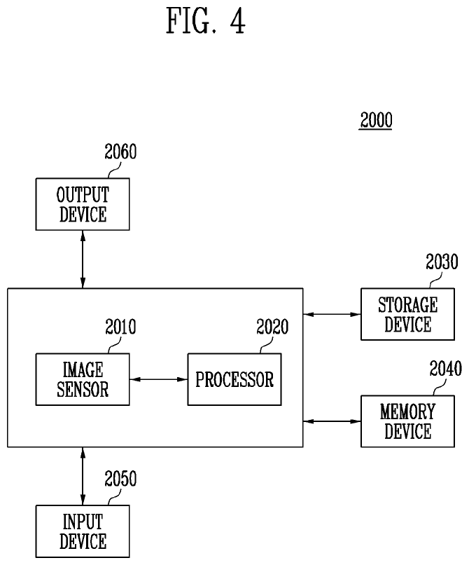

FIG. 4 is a block diagram illustrating an electronic device including an image processing device according to an embodiment of the present disclosure.

Referring to FIG. 4, the electronic device 2000 may include an image sensor 2010, a processor 2020, a storage device 2030, a memory device 2040, an input device 2050, and an output device 2060. Although not shown in FIG. 11, the electronic device 2000 may further include ports capable of communicating with a video card, a memory card, a USB device, or the like, or communicating with other electronic devices.

The image sensor 2010 may generate image data corresponding to incident light. The image data may be transferred to the processor 2020 and processed. The image sensor 2010 may generate image data for an object input (or captured) through a lens. The lens may include at least one lens forming an optical system.

The image sensor 2010 may include a plurality of pixels. The image sensor 2010 may generate a plurality of pixel values corresponding to a captured image from the plurality of pixels. The plurality of pixel values generated by the image sensor 2010 may be transmitted to the processor 2020 as pixel data. That is, the image sensor 2010 may generate a plurality of pixel values corresponding to a single frame.

The output device 2060 may display the image data. The storage device 2030 may store the image data. The processor 2020 may control an operation of the image sensor 2010, the output device 2060, and the storage device 2030.

The processor 2020 may be an image processing device that performs an operation of processing the pixel data received from the image sensor 2010 and outputs the processed image data. Here, the processing may be electronic image stabilization (EIS), interpolation, tone correction, image quality correction, size adjustment, and the like.

In an embodiment of the present disclosure, the processor 2020 may separate a background area and a foreground area of an image from the received pixel data. The processor 2020 may determine a target resolution of a low-resolution sub-image based on an intensity of a blur operation to be performed on the background area, and generate the low-resolution sub-image by performing a downscaling operation on the background area. The processor 2020 may generate an intermediate image in which the blur operation is performed on the low-resolution sub-image and upscale the intermediate image to an original resolution. The processor 2020 may composite the foreground area of the image to the upscaled intermediate image and output the composited blurred image. An image blur processing method of the processor 2020 may decrease a total operation amount. The decreased operation amount may vary according to the intensity of the blur operation. The processor 2020 may adjust the total operation amount according to a depth of field of the blurred image.

The processor 2020 may be implemented as a chip independent of the image sensor 2010. For example, the processor 2020 may be implemented as a multi-chip package. In another embodiment of the present disclosure, the processor 2020 may be included as a part of the image sensor 2010 and implemented as a single chip.

The processor 2020 may execute and control an operation of the electronic device 2000. According to an embodiment of the present disclosure, the processor 2020 may be a microprocessor, a central processing unit (CPU), or an application processor (AP). The processor 2020 may be connected to the storage device 2030, the memory device 2040, the input device 2050, and the output device 2060 through an address bus, a control bus, and a data bus to perform communication.

The storage device 2030 may include a flash memory device, a solid state drive (SSD), a hard disk drive (HDD), a CD-ROM, all types of nonvolatile memory devices, and the like.

The memory device 2040 may store data required for the operation of the electronic device 2000. For example, the memory device 2040 may include a volatile memory device such as a dynamic random access memory (DRAM) or a static random access memory (SRAM) and a nonvolatile memory device such as an erasable programmable read-only memory (EPROM), an electrically erasable programmable read-only memory (EEPROM), and a flash memory device. The processor 2020 may execute a command set stored in the memory device 2040 to control the image sensor 2010 and the output device 2060.

The input device 2050 may include an input means such as a keyboard, a keypad, and a mouse, and the output device 2060 may include an output means such as a printer device and a display.

The image sensor 2010 may be implemented as various types of packages. For example, at least some configurations of the image sensor 2010 may be implemented using packages such as a package on package (PoP), ball grid arrays (BGAs), chip scale packages (CSPs), plastic leaded chip carriers (PLCC), a plastic dual in-line package (PDIP), a die in waffle pack, die in wafer form, a chip on board (COB), a ceramic dual in-line package (CERDIP), a plastic metric quad flat pack (MQFP), a thin quad flat pack (TQFP), a small outline integrated circuit (SOIC), a shrink small outline package (SSOP), a thin small outline package (TSOP), a system in package (SIP), a multi-chip package (MCP), a wafer-level fabricated package (WFP), or a wafer-level processed stack package (WSP).

Meanwhile, the electronic device 2000 may be interpreted as all computing systems using the image sensor 2010. The electronic device 2000 may be implemented in a form of a packaged module, a part, or the like. For example, the electronic device 2000 may be implemented as a digital camera, a mobile device, a smart phone, a personal computer (PC), a tablet personal computer (PC), a notebook, a personal digital assistant (PDA), an enterprise digital assistant (EDA), a portable multimedia player (PMP), a wearable device, a black box, a robot, an autonomous vehicle, or the like.

The scope of the present disclosure is indicated by the claims to be described later rather than the detailed description, and all changes or modifications derived from the meaning and scope of the claims and their equivalent concepts are interpreted as being included in the scope of the present disclosure.

What is claimed is:

1. An image processing device comprising:
a pre-processor configured to extract a background area of an image based on pixel data received from an external device and generate a low-resolution sub-image in which the background area is downscaled;
a background blur component configured to generate an intermediate image in which a blur operation is performed on the low-resolution sub-image and upscale the intermediate image to original resolution; and
an image compositer configured to generate a blurred image in which a foreground area of the image is composited to the upscaled intermediate image.

2. The image processing device of claim 1, wherein the pre-processor determines a target resolution of the low-resolution sub-image based on an intensity of the blur operation, and performs a downscaling operation according to the target resolution.

3. The image processing device of claim 2, wherein the pre-processor determines the target resolution to be less as the intensity of the blur operation increases.

4. The image processing device of claim 2, wherein the pre-processor determines the background area and the foreground area based on depth information of the image.

5. The image processing device of claim 2, wherein the pre-processor performs the downscaling operation in a bilinear interpolation method, and generates the low-resolution sub-image having the target resolution.

6. The image processing device of claim 2, wherein the background blur component determines the intensity of the blur operation based on a depth of field of the blurred image, and performs the blur operation according to the intensity of the blur operation.

7. The image processing device of claim 6, wherein the background blur component determines the intensity of the blur operation to be greater as the depth of field is shallower.

8. The image processing device of claim 6, wherein the background blur component generates a kernel of a point spread function corresponding to the intensity of the blur operation, and performs a convolution operation of the low-resolution sub-image and the kernel.

9. The image processing device of claim 8, wherein the background blur component determines a size of the kernel based on the target resolution.

10. The image processing device of claim 2, wherein the background blur component performs the upscaling operation on the intermediate image in response to the downscaling operation.

11. The image processing device of claim 10, wherein the background blur component performs the upscaling operation in a bicubic interpolation method, and generates the intermediate image having the original resolution.

12. The image processing device of claim 6, wherein the pre-processor determines a size of the extracted background area based on the depth of field.

13. An image processing method comprising:
extracting a background area of an image based on pixel data received from an external device;
generating a low-resolution sub-image in which a downscaling operation is performed on the background area;
performing a blur operation on the low-resolution sub-image;
upscaling an intermediate image on which the blur operation is performed to original resolution; and
compositing the upscaled intermediate image and a foreground area of the image.

14. The image processing method of claim 13, wherein the extracting of the background area comprises:
determining the background area based on depth information of the image; and
determining a size of the background area based on a depth of field for the blur operation.

15. The image processing method of claim 14, wherein generating the low-resolution sub-image comprises:
determining target resolution of the low-resolution sub-image based on the depth of field; and
performing the downscaling operation on the background area in a bilinear interpolation method according to the target resolution.

16. The image processing method of claim 15, wherein performing the blur operation comprises:
determining an intensity of the blur operation based on the target resolution;
generating a kernel of a point spread function corresponding to the intensity of the blur operation; and
performing a convolution operation of the low-resolution sub-image and the kernel.

17. The image processing method of claim 16, wherein generating the kernel of the point spread function comprises determining a size of the kernel based on the target resolution.

18. The image processing method of claim 15, wherein the upscaling comprises:
determining the original resolution corresponding to the target resolution;
upscaling the intermediate image in a bicubic interpolation method; and
generating the intermediate image having the original resolution.

19. The image processing method of claim 13, wherein compositing the intermediate image and the foreground area comprises generating a blurred image in which the foreground area is composited to the intermediate image having the same resolution as the foreground area.

20. An image processing system comprising:
an image sensor configured to generate pixel data including brightness information and depth information; and
an image processing device configured to generate a blurred image in which a background area of an image is blurred based on the pixel data,
wherein the image processing device comprises:
a pre-processor configured to extract the background area of the image based on the depth information and generate a low-resolution sub-image for the background area based on an intensity of a blur operation;
a background blur component configured to generate an intermediate image in which the blur operation is performed on the low-resolution sub-image and increase resolution of the intermediate image; and
an image compositer configured to composite the intermediate image of which resolution is increased to a foreground area of the image.
